(19) United States
(12) Patent Application Publication
(10) Pub. No.: US 2026/0205900 A1
(43) Pub. Date: Jul. 16, 2026

(54) TIMING ADVANCE VALIDATION FOR SMALL DATA TRANSMISSION IN A WIRELESS NETWORK

(71) Applicant: APPLE INC., Cupertino, CA (US)

(72) Inventors: Jie Cui, San Jose, CA (US); Hong He, San Jose, CA (US); Yang Tang, San Jose, CA (US); Qiming Li, Beijing (CN); Manasa Raghavan, Sunnyvale, CA (US); Xiang Chen, Campbell, CA (US); Yuexia Song, Beijing (CN); Rolando E. Bettancourt Ortega, Munich (DE); Dawei Zhang, Saratoga, CA (US); Haitong Sun, Cupertino, CA (US)

(21) Appl. No.: 19/145,118

(22) PCT Filed: Jan. 23, 2024
(86) PCT No.: PCT/CN2024/073646

§ 371 Date: Jul. 1, 2025

Related U.S. Application Data
(60) Provisional application No. 63/484,299, filed on Feb. 10, 2023.

(51) Int. Cl. H04W 36/00; G01S 19/39; H04L 47/283

(52) U.S. Cl. CPC H04W 36/0072; G01S 19/39; H04L 47/283

(57) ABSTRACT

Apparatus and methods provide distance based timing advance (TA) validation. A user equipment (UE) stores a TA value, determines an estimated distance variation within a first time window and a second time window, and compares the estimated distance variation with a TA validation threshold to determine whether the TA value is valid. A base station may receive UE movement information and perform distance based TA validation for the UE. Alternatively, small data transmission may also be achieved without TA validation.

### TECHNICAL FIELD

This application relates generally to wireless communication systems, including timing advance (TA) validation for small data transmission (SDT).

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a timing diagram for TA validation for SDT used in certain wireless systems and modified according to certain embodiments.

FIG. 2 illustrates an example ATG network deployment that may be used in certain wireless systems.

FIG. 3 illustrates an example ATG network deployment using TA validation based on UE moving distance according to one embodiment.

FIG. 4 illustrates a flowchart of a method of a UE for TA validation in a wireless network according to one embodiment.

FIG. 5 illustrates a flowchart of a method of a base station to perform SDT TA validation for a UE in a wireless network according to one embodiment.

FIG. 6 illustrates a flowchart of a method performed by a UE in a wireless network according to one embodiment.

FIG. 7 illustrates a flowchart of a method performed by a UE for SDT without TA validation according to one embodiment.

FIG. 8 illustrates an example architecture of a wireless communication system, according to embodiments disclosed herein.

FIG. 9 illustrates a system for performing signaling between a wireless device and a network device, according to embodiments disclosed herein.

### DETAILED DESCRIPTION

Various embodiments are described with regard to a UE or an air-to-ground (ATG or A2G) UE. However, reference to a UE or ATG UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

A change in transmission timing at a UE may be referred to as a timing advance (TA) adjustment. A TA may be used to adjust signals with differing arrival times due to differing distances traveled of component carrier signals at either the gNB or at the UE. A TA value may be, for example, one value, a combination of values that are weighted equally, or a combination of values that may have different weights. A TA adjustment may be made to one signal or multiple signals depending on many factors such as distance traveled by the signal or by arrival timing. Multiple small timing advances may be performed in lieu of a single large timing advance or a large timing advance may be conducted to synchronize signals. Synchronization of signals may depend on environmental conditions and system design and may be defined by the system or implementation of the timing advance. A timing advance between the UE and the gNB may be maintained by periodically performing adjustments on the timing advance. TA may be implemented as a TA command wherein a multi-bit command may be used to indicate a TA value or whether a TA is to be used for signal synchronization. TA may also be implemented as an average of TAs received from surrounding UEs.

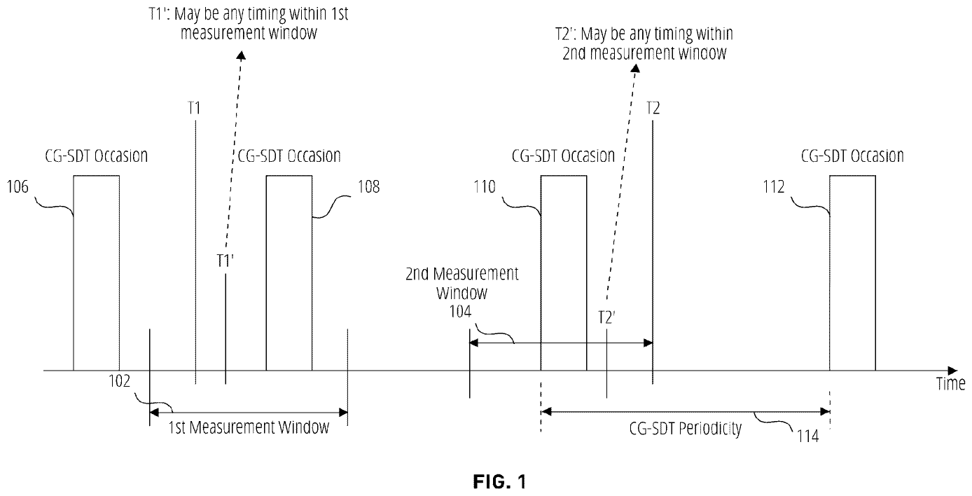

FIG. 1 illustrates a timing diagram for TA validation for SDT used in certain wireless systems and modified according to certain embodiments. In such systems, a UE determines a delta reference signal received power (RSRP) between a first RSRP measurement in a first measurement window 102 and second RSRP measurement in a second measurement window 104. The UE then determine whether the delta RSRP meets a configured threshold.

As shown in FIG. 1, the first measurement window 102 corresponds to a first time T1 and the second measurement window 104 corresponds to a second time T2 relative to a plurality of configure grant (CG) SDT occasions (e.g., shown as CG-SDT occasion 106, CG-SDT occasion 108, CG-SDT occasion 110, and CG-SDT occasion 112). A CG-SDT periodicity 114 corresponds to a duration between successive CG-SDT occasions.

The first time T1 is when the UE receives a radio resource control (RRC) release (RRCRelease) with a CG-SDT configuration and the UE receives a latest TA value, if the TA value is received while the UE is an RRC inactive state (RRC_INACTIVE). A first measurement time T1′ is when the UE has completed the first RSRP measurement and may be at any timing within the first measurement window 102. The second time T2 is when the UE performs TA validation (see, e.g., clause 5.27.2 in 3GPP Technical Specification (TS) 38.321) to determine whether the latest or current TA value may be used for an uplink transmission using the CG-SDT occasion 112. A second measurement time T2′ is when the UE has completed the second RSRP measurement and may be at any timing within the second measurement window 104.

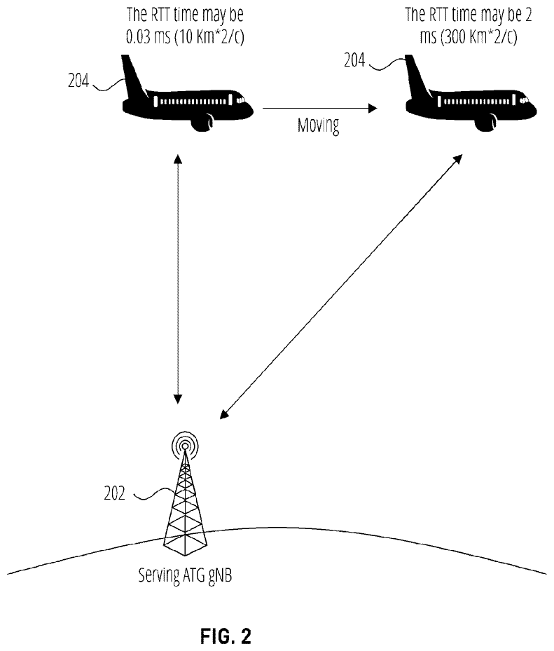

In certain communication systems, ATG network deployment may cause problems with TA validation for SDT at ATG UEs. For example, FIG. 2 illustrates an example ATG network deployment that may be used in certain wireless systems. In this example, a Serving ATG gNB 202 is in communication with a moving ATG UE 204. As illustrated, the ATG UE 204 may be associated with an aircraft. However, the present disclosure is not so limited and skilled persons will recognized that any other mobile UE and/or vehicle may be used. Further, ATG UE and UE may be used interchangeably herein.

The ATG network deployment may have an extremely large cell coverage range (e.g., up to 300 kilometers (Km)) and flight speed (e.g., up to 1200 Km/hour). Thus, when the ATG UE 204 is nearer the Serving ATG gNB 202 the round trip time (RTT) for signal transmission and reception may be much shorter than when the ATG UE 204 is further from the Serving ATG gNB 202. In the illustrated example, the RTT may be 0.03 milliseconds (ms) (e.g., 10 Km*2/c, where c is the speed of light or propagation speed of the signals) at a first time and 2 ms (e.g., 300Km*2/c) at a second time. Such large variations in RTT may increase the difficulty of TA validation, particularly when attempting to maintain coexistence between ATG networks and terrestrial networks and/or attempting to meet ATG base station and UE core and performance requirements.

Embodiments disclosed herein enhance TA validation for high velocity and large inter-site-distances (ISD) of cell deployment. In certain embodiments, a distance based TA validation is used rather than, or in addition to, an RSRP based TA validation. In addition, or in other embodiments, TA validation timing and measurement windows are provided for TA validation using SDT for ATG communications. Other embodiments provide adaptive TA or SDT without validation, including for both an initial SDT transmission and subsequent SDT transmissions.

### TA Validation Based on Distance Between UE and Base Station

In certain embodiments, the network shares base station location information (i.e., location (x, y, z coordinates) of a serving ATG gNB) with a UE (e.g., an ATG UE). Referring again to FIG. 1, the UE may use an estimated distance within the first measurement window 102 and the second measurement window 104 to perform the TA validation for an initial SDT transmission (i.e., instead of basing the TA validation on a first RSRP measurement and a second RSRP measurement).

In such embodiments, the first time T1 is when the UE receives an RRC release (RRCRelease) with a CG-SDT configuration, and when the UE receives the latest TA while the UE is in the RRC inactive state (RRC_INACTIVE) and/or when the UE has updated its UE specific TA based on the UE's location. The UE's location (x, y, z coordinates) may be based on a global navigation satellite system (GNSS) location measurement. The UE specific TA may be the TA or RTT calculated based on the UE's location and the serving ATG gNB's location. The first measurement time T1′ is when the UE has completed the GNSS measurement and a corresponding first distance estimation (i.e., distance between the UE and the serving ATG gNB) within the first measurement window 102.

The second time T2 is when the UE performs TA validation (see, e.g., clause 5.27.2 in 3GPP TS 38.321) to determine whether the latest TA value or the UE specific TA value may be used for an uplink transmission using the CG-SDT occasion 112. The second measurement time T2′ is when the UE has completed the GNSS measurement and a corresponding second distance estimation (i.e., distance between the UE and the serving ATG gNB).

The UE may determine a difference or delta value between the first distance estimation and the second distance estimation, and check whether the delta of the distances exceeds a distance threshold or a corresponding RTT threshold of the TA validation. The first distance estimation may be an actual distance value or a corresponding RTT value between the UE and the gNB within the first measurement window 102. The second distance estimation may be an actual distance value or a corresponding RTT value between the UE and the gNB within the second measurement window 104. The distance threshold or RTT threshold may be configured by the network or may be predetermined (i.e., defined in a specification).

For a subsequent SDT transmission after the initial SDT transmission, the UE may apply a UE specific TA estimated by the UE and a received TA command from network on downlink (DL) reception time to determine the SDT transmission timing.

Distance based TA validation increases efficiency and accuracy as compared to RSRP based TA validation in ATG communication scenarios, for example, because RSRP measurements use Layer 1 and Layer 2 filtering and combine multiple samples together. Thus, determining an RSRP value can take relatively longer than acquiring GNSS location coordinates. Further, the distance between the UE and the base station can be directly mapped to TA values or timing information, whereas RSRP measurements may be impacted by channel conditions unrelated to timing.

### TA Validation Based on UE Moving Distance

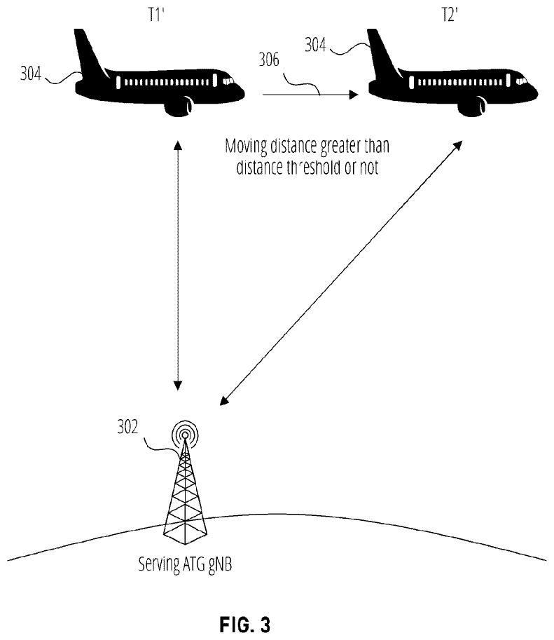

In certain embodiments, a UE uses an estimated moving distance between the first measurement window 102 and the second measurement window 104 to perform the TA validation for an initial SDT transmission (i.e., instead of basing the TA validation on a first RSRP measurement and a second RSRP measurement). For example, FIG. 3 illustrates an example ATG network deployment using TA validation based on UE moving distance 306 according to one embodiment. In this example, a serving ATG gNB 302 is in communication with a moving ATG UE 304. As illustrated, the ATG UE 304 may be associated with an aircraft. However, the present disclosure is not so limited and skilled persons will recognized that any other mobile UE and/or vehicle may be used.

With reference to FIG. 1 and FIG. 3, the first time T1 is when the UE receives an RRC release (RRCRelease) with a CG-SDT configuration, and when the UE receives the latest TA while the UE is in the RRC inactive state (RRC_INACTIVE) and/or when the UE has updated its UE specific TA based on the UE's GNSS measurement. The UE specific TA may be the TA or RTT calculated based on the UE's location change. The first measurement time T1′ is when the UE has completed the GNSS measurement in the first measurement window 102 and a corresponding first location estimation.

The second time T2 is when the UE performs TA validation (see, e.g., clause 5.27.2 in 3GPP TS 38.321) to determine whether the latest TA value or the UE specific TA value may be used for an uplink transmission using the CG-SDT occasion 112. The second measurement time T2′ is when the UE has completed the GNSS measurement in the second measurement window 104 and a corresponding second location estimation.

The UE may determine a difference or delta distance between the first location estimation and the second location estimation, and check whether the delta distance exceeds a moving distance threshold of the TA validation. The first location estimation correspond to the location of the UE at the first measurement time T1′ within the first measurement window 102. The second distance estimation corresponds to the location of the UE at the second measurement time T2′ within the second measurement window 104.

The moving distance threshold may be configured by the network or may be predetermined (i.e., defined in a specification).

For a subsequent SDT transmission after the initial SDT transmission, the UE may apply a UE specific TA estimated by the UE and a received TA command from network on DL reception time to determine the SDT transmission timing.

TA validation based on UE moving distance may increase efficiency and accuracy in ATG communication scenarios, for example, because ATG gNBs may be distributed in selected patterns (e.g., a straight line or rectangle) in an area based on known flight paths.

Thus, the distance that the UE moves between two times can be quickly associated with a distance to a serving ATG gNB and corresponding timing information based on the flight path information. In certain embodiments, the network may select between TA validation based on UE moving distance when ATG gNB location patterns are coordinated with flight path information, and distance based TA validation when the ATG gNB location patterns and flight paths are not coordinated or flight path information is not available to the network.

### Network Determination of TA Validation

In certain embodiments, a UE reports UE movement information (e.g., UE location, UE speed or velocity, and UE trajectory) to a base station, and the base station performs TA validation for an initial SDT transmission based on the UE movement information and the base station's location (i.e., instead of basing the TA validation on a first RSRP measurement and a second RSRP measurement).

The network (i.e., base station or gNB) sends an RRC release (RRCRelease) with a CG-SDT configuration to the UE as well as the TA information based on the distance between the UE and the network. The network may update the TA information to the UE based on the UE movement information (location, speed or velocity, and trajectory) periodically or aperiodically after the RRC release with the CG-SDT configuration. This may occur aperiodically because when the TA or RTT change is greater than a threshold, the network may trigger to update the TA for the UE. The network may set a SDT timer to the UE. Within the SDT timer, the UE is allowed to send the initial SDT using the updated TA information. If the UE has data in the buffer to transmit, the UE may transmit the SDT directly without the UE performing its own TA validation. The UE may transmit subsequent SDT based on the latest TA information from the network until the TA information is updated or the SDT timer has expired.

### SDT Without TA Validation

In certain embodiments, the network shares gNB location information to the UE, and the UE uses an estimated distance between the UE and the gNB to determine a UE specific TA or RTT. If a UE measured RSRP of the serving cell is above an RSRP threshold, or the distance between UE and gNB is below a distance threshold of the serving cell and an SDT timer is running or not expired, the UE may perform SDT transmission based on its UE specific TA without any additional TA validation.

### Example Embodiments

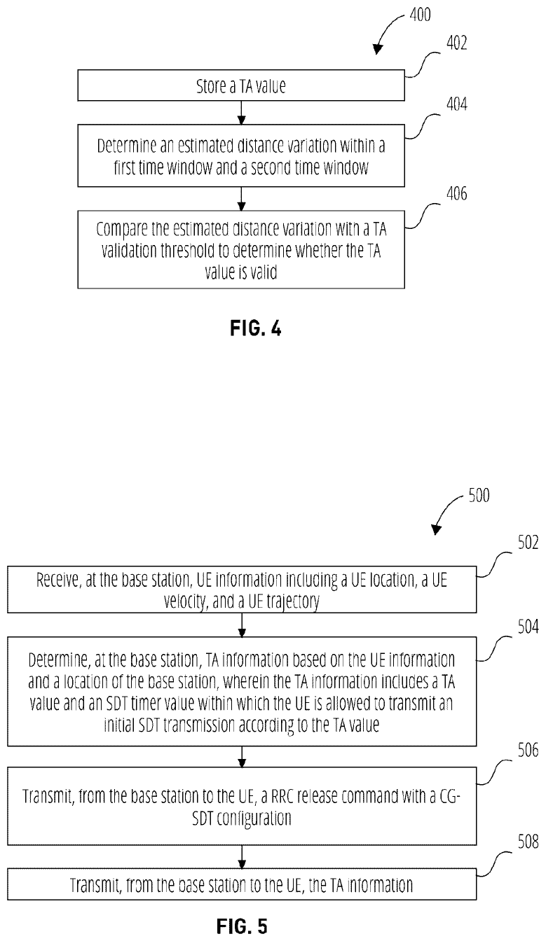

FIG. 4 illustrates a flowchart of a method 400 of a UE for TA validation in a wireless network according to one embodiment. The method 400 includes storing 402 a TA value, determining 404 an estimated distance variation within a first time window and a second time window, and comparing 406 the estimated distance variation with a TA validation threshold to determine whether the TA value is valid.

In one embodiment of the method 400, determining the estimated distance variation further comprises: receiving, at the UE from the wireless network, base station location information; in the first time window, estimating a first distance between the UE and a base station based on a first GNSS location measurement of the UE and the base station location information; and in the second time window, estimating a second distance between the UE and the base station based on a second GNSS location measurement of the UE and the base station location information. The estimated distance variation may include a difference between the first distance and the second distance. In one such embodiment, the TA validation threshold corresponds to a distance value between the UE and the base station or an RTT value of a signal transmitted between the UE and the base station.

In certain embodiments, the first time window is based on a first time T1 corresponding to receiving, at the UE from the wireless network, an RRC release command with a CG-SDT configuration and at least one of: receiving, at the UE from the wireless network, a latest TA value while the UE is in an RRC inactive state; and updating, by the UE, a UE specific TA based on the first GNSS location measurement of the UE and the base station location information. A first measurement time T1′ within the first time window corresponds to the UE completing the first GNSS location measurement and estimating the first distance between the UE and the base station. In one such embodiment, the second time window is based on a second time T2 when the UE performs the TA validation for transmission using the CG-SDT, and a second measurement time T2′ within the second time window corresponds to the UE completing the second GNSS location measurement and estimating the second distance between the UE and the base station.

In one embodiment of the method 400, determining the estimated distance variation comprises: in the first time window, estimating a first location of the UE based on a first GNSS location measurement; in the second time window, estimating a second location of the UE based on a second GNSS location measurement; and determining a moving distance of the UE between the first location and the second location, wherein the TA validation threshold comprises a moving distance threshold value. In one such embodiment, the first time window is based on a first time T1 corresponding to receiving, at the UE from the wireless network, an RRC release command with a CG-SDT configuration and at least one of: receiving, at the UE from the wireless network, a latest TA value while the UE is in an RRC inactive state; and updating, by the UE, a UE specific TA based on the first GNSS location measurement of the UE and a UE location change, and wherein a first measurement time T1′ within the first time window corresponds to the UE completing the first GNSS location measurement and estimating the first location of the UE. In one such embodiment, the second time window is based on a second time T2 when the UE performs the TA validation for transmission using the CG-SDT, and a second measurement time T2′ within the second time window corresponds to the UE completing the second GNSS location measurement and estimating the second location of the UE.

In one embodiment of the method 400, durations of the first time window and the second time window are predetermined or configured to the UE by the wireless network.

In one embodiment, the method 400 further comprises: in response to determining that the TA value is valid, sending an initial SDT from the UE to a base station; applying a UE specific TA estimated by the UE and a received TA command on a downlink reception timing from the wireless network to determine an STD transmission timing; and using the STD transmission timing to send one or more subsequent SDT from the UE to the base station after the initial SDT.

FIG. 5 illustrates a flowchart of a method 500 of a base station to perform SDT TA validation for a UE in a wireless network according to one embodiment. The method 500 includes, receiving 502, at the base station, UE information including a UE location, a UE velocity, and a UE trajectory. The method 500 further includes determining 504, at the base station, TA information based on the UE information and a location of the base station, wherein the TA information includes a TA value and an SDT timer value within which the UE is allowed to transmit an initial SDT transmission according to the TA value. The method 500 further includes transmitting 506, from the base station to the UE, a RRC release command with a CG-SDT configuration. The method 500 further includes transmitting 508, from the base station to the UE, the TA information.

In one embodiment, the method 500 further comprises transmitting, from the base station to the UE, updated TA information based on the UE information and the location of the base station. In one such embodiment, the base station periodically transmits the updated TA information after the RRC release with the CG-SDT configuration. In another embodiment, the base station aperiodically transmits the updated TA information after the RRC release with the CG-SDT configuration based on a TA change or a RTT change that is greater than a threshold value.

In one embodiment of the method 500, receiving the UE information comprises receiving the UE information at the base station from the UE.

In one embodiment of the method 500, receiving the UE information comprises receiving the UE information at the base station from a traffic control system.

Embodiments contemplated herein include an apparatus comprising means to perform one or more elements of the method 500. This apparatus may be, for example, an apparatus of a base station (such as a network device 918 that is a base station, as described herein).

Embodiments contemplated herein include one or more non-transitory computer-readable media comprising instructions to cause an electronic device, upon execution of the instructions by one or more processors of the electronic device, to perform one or more elements of the method 500. This non-transitory computer-readable media may be, for example, a memory of a base station (such as a memory 922 of a network device 918 that is a base station, as described herein).

Embodiments contemplated herein include an apparatus comprising logic, modules, or circuitry to perform one or more elements of the method 500. This apparatus may be, for example, an apparatus of a base station (such as a network device 918 that is a base station, as described herein).

Embodiments contemplated herein include an apparatus comprising: one or more processors and one or more computer-readable media comprising instructions that, when executed by the one or more processors, cause the one or more processors to perform one or more elements of the method 500. This apparatus may be, for example, an apparatus of a base station (such as a network device 918 that is a base station, as described herein).

Embodiments contemplated herein include a signal as described in or related to one or more elements of the method 500.

Embodiments contemplated herein include a computer program or computer program product comprising instructions, wherein execution of the program by a processing element is to cause the processing element to carry out one or more elements of the method 500. The processor may be a processor of a base station (such as a processor(s) 920 of a network device 918 that is a base station, as described herein). These instructions may be, for example, located in the processor and/or on a memory of the base station (such as a memory 922 of a network device 918 that is a base station, as described herein).

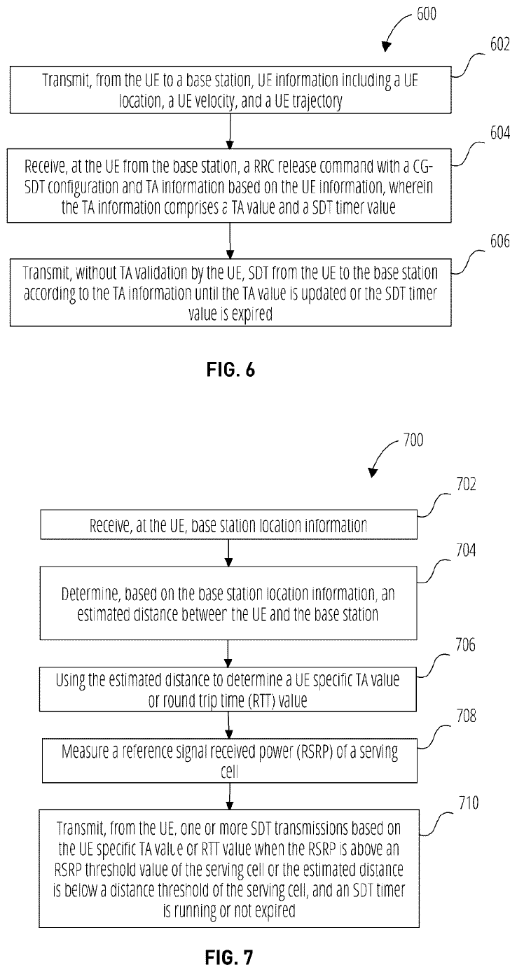

FIG. 6 illustrates a flowchart of a method 600 performed by a UE in a wireless network according to one embodiment. The method 600 includes transmitting 602, from the UE to a base station, UE information including a UE location, a UE velocity, and a UE trajectory. The method 600 also includes receiving 604, at the UE from the base station, a RRC release command with a CG-SDT configuration and TA information based on the UE information, wherein the TA information comprises a TA value and a SDT timer value. The method 600 further includes transmitting 606, without TA validation by the UE, SDT from the UE to the base station according to the TA information until the TA value is updated or the SDT timer value is expired.

In one embodiment, the method 600 further comprises periodically receiving, at the UE from the base station, updated TA information after the RRC release with the CG-SDT configuration.

In one embodiment, the method 600 further comprises aperiodically receiving, at the UE from the base station, updated TA information after the RRC release with the CG-SDT configuration based on a TA change or a RTT change that is greater than a threshold value.

FIG. 7 illustrates a flowchart of a method 700 performed by a UE for SDT without TA validation according to one embodiment. The method 700 includes receiving 702, at the UE, base station location information. The method 700 also includes determining 704, based on the base station location information, an estimated distance between the UE and the base station. The method 700 also includes using 706 the estimated distance to determine a UE specific TA value or RTT value, and measuring 708 an RSRP of a serving cell. The method 700 also includes transmitting 710, from the UE, one or more SDT transmissions based on the UE specific TA value or RTT value when: the RSRP is above an RSRP threshold value of the serving cell or the estimated distance is below a distance threshold of the serving cell; and an SDT timer is running or not expired.

Embodiments contemplated herein include an apparatus comprising means to perform one or more elements of a process performed by a UE, such as the method 400, the method 600, or the method 700. This apparatus may be, for example, an apparatus of a UE (such as a wireless device 902 that is a UE, as described herein).

Embodiments contemplated herein include one or more non-transitory computer-readable media comprising instructions to cause an electronic device, upon execution of the instructions by one or more processors of the electronic device, to perform one or more elements of a process performed by a UE, such as the method 400, the method 600, or the method 700. This non-transitory computer-readable media may be, for example, a memory of a UE (such as a memory 906 of a wireless device 902 that is a UE, as described herein).

Embodiments contemplated herein include an apparatus comprising logic, modules, or circuitry to perform one or more elements of a process performed by a UE, such as the method 400, the method 600, or the method 700. This apparatus may be, for example, an apparatus of a UE (such as a wireless device 902 that is a UE, as described herein).

Embodiments contemplated herein include an apparatus comprising: one or more processors and one or more computer-readable media comprising instructions that, when executed by the one or more processors, cause the one or more processors to perform one or more elements of a process performed by a UE, such as the method 400, the method 600, or the method 700. This apparatus may be, for example, an apparatus of a UE (such as a wireless device 902 that is a UE, as described herein).

Embodiments contemplated herein include a signal as described in or related to one or more elements of a process performed by a UE, such as the method 400, the method 600, or the method 700.

Embodiments contemplated herein include a computer program or computer program product comprising instructions, wherein execution of the program by a processor is to cause the processor to carry out one or more elements of a process performed by a UE, such as the method 400, the method 600, or the method 700. The processor may be a processor of a UE (such as a processor(s) 904 of a wireless device 902 that is a UE, as described herein). These instructions may be, for example, located in the processor and/or on a memory of the UE (such as a memory 906 of a wireless device 902 that is a UE, as described herein).

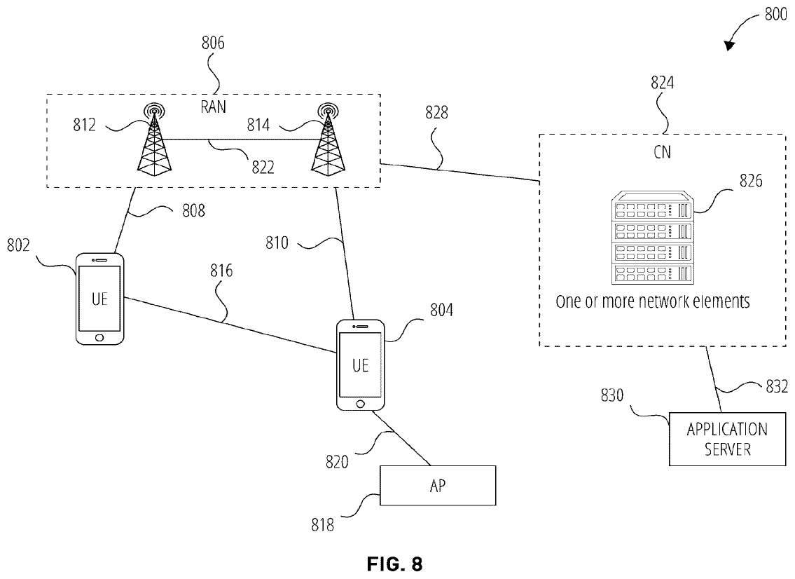

FIG. 8 illustrates an example architecture of a wireless communication system 800, according to embodiments disclosed herein. The following description is provided for an example wireless communication system 800 that operates in conjunction with the LTE system standards and/or 5G or NR system standards as provided by 3GPP technical specifications.

As shown by FIG. 8, the wireless communication system 800 includes UE 802 and UE 804 (although any number of UEs may be used). In this example, the UE 802 and the UE 804 are illustrated as smartphones (e.g., handheld touchscreen mobile computing devices connectable to one or more cellular networks), but may also comprise any mobile or non-mobile computing device configured for wireless communication.

The UE 802 and UE 804 may be configured to communicatively couple with a RAN 806. In embodiments, the RAN 806 may be NG-RAN, E-UTRAN, etc. The UE 802 and UE 804 utilize connections (or channels) (shown as connection 808 and connection 810, respectively) with the RAN 806, each of which comprises a physical communications interface. The RAN 806 can include one or more base stations (such as base station 812 and base station 814) that enable the connection 808 and connection 810.

In this example, the connection 808 and connection 810 are air interfaces to enable such communicative coupling, and may be consistent with RAT(s) used by the RAN 806, such as, for example, an LTE and/or NR.

In some embodiments, the UE 802 and UE 804 may also directly exchange communication data via a sidelink interface 816. The UE 804 is shown to be configured to access an access point (shown as AP 818) via connection 820. By way of example, the connection 820 can comprise a local wireless connection, such as a connection consistent with any IEEE 802.11 protocol, wherein the AP 818 may comprise a Wi-Fi® router. In this example, the AP 818 may be connected to another network (for example, the Internet) without going through a CN 824.

In embodiments, the UE 802 and UE 804 can be configured to communicate using orthogonal frequency division multiplexing (OFDM) communication signals with each other or with the base station 812 and/or the base station 814 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 812 or base station 814 may be implemented as one or more software entities running on server computers as part of a virtual network. In addition, or in other embodiments, the base station 812 or base station 814 may be configured to communicate with one another via interface 822. In embodiments where the wireless communication system 800 is an LTE system (e.g., when the CN 824 is an EPC), the interface 822 may be an X2 interface. The X2 interface may be defined between two or more base stations (e.g., two or more eNBs and the like) that connect to an EPC, and/or between two eNBs connecting to the EPC. In embodiments where the wireless communication system 800 is an NR system (e.g., when CN 824 is a 5GC), the interface 822 may be an Xn interface. The Xn interface is defined between two or more base stations (e.g., two or more gNBs and the like) that connect to 5GC, between a base station 812 (e.g., a gNB) connecting to 5GC and an eNB, and/or between two eNBs connecting to 5GC (e.g., CN 824).

The RAN 806 is shown to be communicatively coupled to the CN 824. The CN 824 may comprise one or more network elements 826, which are configured to offer various data and telecommunications services to customers/subscribers (e.g., users of UE 802 and UE 804) who are connected to the CN 824 via the RAN 806. The components of the CN 824 may be implemented in one physical device or separate physical devices including components to read and execute instructions from a machine-readable or computer-readable medium (e.g., a non-transitory machine-readable storage medium).

In embodiments, the CN 824 may be an EPC, and the RAN 806 may be connected with the CN 824 via an S1 interface 828. In embodiments, the S1 interface 828 may be split into two parts, an S1 user plane (S1-U) interface, which carries traffic data between the base station 812 or base station 814 and a serving gateway (S-GW), and the S1-MME interface, which is a signaling interface between the base station 812 or base station 814 and mobility management entities (MMEs).

In embodiments, the CN 824 may be a 5GC, and the RAN 806 may be connected with the CN 824 via an NG interface 828. In embodiments, the NG interface 828 may be split into two parts, an NG user plane (NG-U) interface, which carries traffic data between the base station 812 or base station 814 and a user plane function (UPF), and the S1 control plane (NG-C) interface, which is a signaling interface between the base station 812 or base station 814 and access and mobility management functions (AMFs).

Generally, an application server 830 may be an element offering applications that use internet protocol (IP) bearer resources with the CN 824 (e.g., packet switched data services). The application server 830 can also be configured to support one or more communication services (e.g., VoIP sessions, group communication sessions, etc.) for the UE 802 and UE 804 via the CN 824. The application server 830 may communicate with the CN 824 through an IP communications interface 832.

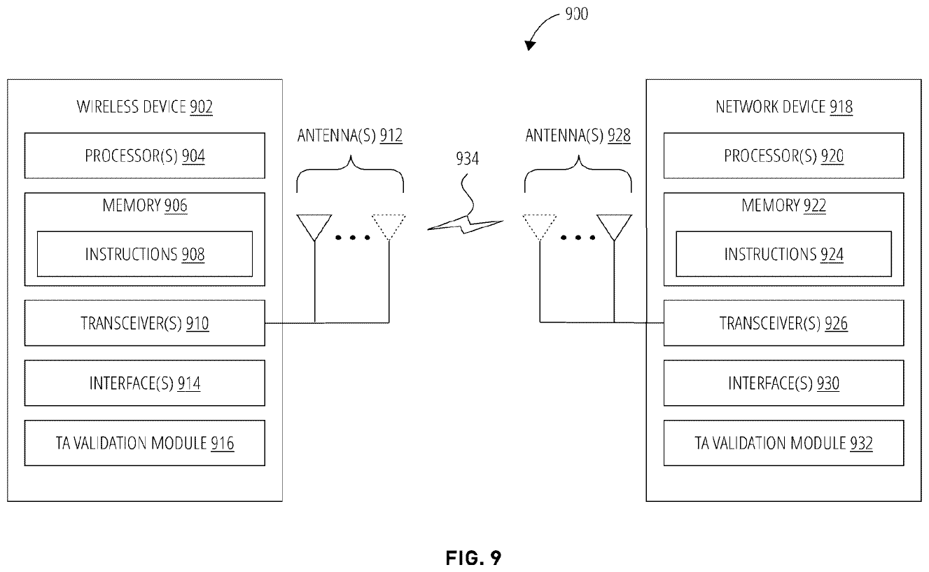

FIG. 9 illustrates a system 900 for performing signaling 934 between a wireless device 902 and a network device 918, according to embodiments disclosed herein. The system 900 may be a portion of a wireless communications system as herein described. The wireless device 902 may be, for example, a UE of a wireless communication system. The network device 918 may be, for example, a base station (e.g., an eNB or a gNB) of a wireless communication system.

The wireless device 902 may include one or more processor(s) 904. The processor(s) 904 may execute instructions such that various operations of the wireless device 902 are performed, as described herein. The processor(s) 904 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 902 may include a memory 906. The memory 906 may be a non-transitory computer-readable storage medium that stores instructions 908 (which may include, for example, the instructions being executed by the processor(s) 904). The instructions 908 may also be referred to as program code or a computer program. The memory 906 may also store data used by, and results computed by, the processor(s) 904.

The wireless device 902 may include one or more transceiver(s) 910 that may include radio frequency (RF) transmitter and/or receiver circuitry that use the antenna(s) 912 of the wireless device 902 to facilitate signaling (e.g., the signaling 934) to and/or from the wireless device 902 with other devices (e.g., the network device 918) according to corresponding RATs.

The wireless device 902 may include one or more antenna(s) 912 (e.g., one, two, four, or more). For embodiments with multiple antenna(s) 912, the wireless device 902 may leverage the spatial diversity of such multiple antenna(s) 912 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 902 may be accomplished according to precoding (or digital beamforming) that is applied at the wireless device 902 that multiplexes the data streams across the antenna(s) 912 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 902 may implement analog beamforming techniques, whereby phases of the signals sent by the antenna(s) 912 are relatively adjusted such that the (joint) transmission of the antenna(s) 912 can be directed (this is sometimes referred to as beam steering).

The wireless device 902 may include one or more interface(s) 914. The interface(s) 914 may be used to provide input to or output from the wireless device 902. For example, a wireless device 902 that is a UE may include interface(s) 914 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 910/antenna(s) 912 already described) that allow for communication between the UE and other devices and may operate according to known protocols (e.g., Wi-Fi®, Bluetooth®, and the like).

The wireless device 902 may include a TA validation module 916. The TA validation module 916 may be implemented via hardware, software, or combinations thereof. For example, the TA validation module 916 may be implemented as a processor, circuit, and/or instructions 908 stored in the memory 906 and executed by the processor(s) 904. In some examples, the TA validation module 916 may be integrated within the processor(s) 904 and/or the transceiver(s) 910. For example, the TA validation module 916 may be implemented by a combination of software components (e.g., executed by a DSP or a general processor) and hardware components (e.g., logic gates and circuitry) within the processor(s) 904 or the transceiver(s) 910.

The TA validation module 916 may be used for various aspects of the present disclosure, for example, aspects of FIG. 1, FIG. 3, FIG. 4, FIG. 6, and FIG. 7. The TA validation module 916 may be configured to validate timing advance for small data transmissions at ATG UEs, as described herein.

The network device 918 may include one or more processor(s) 920. The processor(s) 920 may execute instructions such that various operations of the network device 918 are performed, as described herein. The processor(s) 920 may include one or more baseband processors implemented using, for example, a CPU, a DSP, an ASIC, a controller, an FPGA device, another hardware device, a firmware device, or any combination thereof configured to perform the operations described herein.

The network device 918 may include a memory 922. The memory 922 may be a non-transitory computer-readable storage medium that stores instructions 924 (which may include, for example, the instructions being executed by the processor(s) 920). The instructions 924 may also be referred to as program code or a computer program. The memory 922 may also store data used by, and results computed by, the processor(s) 920.

The network device 918 may include one or more transceiver(s) 926 that may include RF transmitter and/or receiver circuitry that use the antenna(s) 928 of the network device 918 to facilitate signaling (e.g., the signaling 934) to and/or from the network device 918 with other devices (e.g., the wireless device 902) according to corresponding RATs.

The network device 918 may include one or more antenna(s) 928 (e.g., one, two, four, or more). In embodiments having multiple antenna(s) 928, the network device 918 may perform MIMO, digital beamforming, analog beamforming, beam steering, etc., as has been described.

The network device 918 may include one or more interface(s) 930. The interface(s) 930 may be used to provide input to or output from the network device 918. For example, a network device 918 that is a base station may include interface(s) 930 made up of transmitters, receivers, and other circuitry (e.g., other than the transceiver(s) 926/antenna(s) 928 already described) that enables the base station to communicate with other equipment in a core network, and/or that enables the base station to communicate with external networks, computers, databases, and the like for purposes of operations, administration, and maintenance of the base station or other equipment operably connected thereto.

The network device 918 may include a TA validation module 932. The TA validation module 932 may be implemented via hardware, software, or combinations thereof. For example, the TA validation module 932 may be implemented as a processor, circuit, and/or instructions 924 stored in the memory 922 and executed by the processor(s) 920. In some examples, the TA validation module 932 may be integrated within the processor(s) 920 and/or the transceiver(s) 926. For example, the TA validation module 932 may be implemented by a combination of software components (e.g., executed by a DSP or a general processor) and hardware components (e.g., logic gates and circuitry) within the processor(s) 920 or the transceiver(s) 926.

The TA validation module 932 may be used for various aspects of the present disclosure, for example, aspects of FIG. 1, FIG. 3, and FIG. 5. The TA validation module 932 may be configured, for example, to validate timing advance for small data transmissions, as described herein.

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein.

For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A method performed by a user equipment (UE) for timing advance (TA) validation in a wireless network, the method comprising:
storing a TA value;
determining an estimated distance variation within a first time window and a second time window; and
comparing the estimated distance variation with a TA validation threshold to determine whether the TA value is valid.

2. The method of claim 1, wherein determining the estimated distance variation comprises:
receiving, at the UE from the wireless network, base station location information;
in the first time window, estimating a first distance between the UE and a base station based on a first global navigation satellite system (GNSS) location measurement of the UE and the base station location information; and
in the second time window, estimating a second distance between the UE and the base station based on a second GNSS location measurement of the UE and the base station location information,
wherein the estimated distance variation comprises a difference between the first distance and the second distance.

3. The method of claim 2, wherein the TA validation threshold corresponds to a distance value between the UE and the base station or a round trip time (RTT) value of a signal transmitted between the UE and the base station.

4. The method of claim 2, wherein the first time window is based on a first time (T1) corresponding to:
receiving, at the UE from the wireless network, a radio resource control (RRC) release command with a configured grant small data transmission (CG-SDT) configuration; and
at least one of:
receiving, at the UE from the wireless network, a latest TA value while the UE is in an RRC inactive state; and
updating, by the UE, a UE specific TA based on the first GNSS location measurement of the UE and the base station location information, and
wherein a first measurement time (T1′) within the first time window corresponds to the UE completing the first GNSS location measurement and estimating the first distance between the UE and the base station.

5. The method of claim 4, wherein the second time window is based on a second time (T2) when the UE performs the TA validation for transmission using the CG-SDT, and
wherein a second measurement time (T2′) within the second time window corresponds to the UE completing the second GNSS location measurement and estimating the second distance between the UE and the base station.

6. The method of claim 1, wherein determining the estimated distance variation comprises:
in the first time window, estimating a first location of the UE based on a first global navigation satellite system (GNSS) location measurement;
in the second time window, estimating a second location of the UE based on a second GNSS location measurement; and
determining a moving distance of the UE between the first location and the second location, and
wherein the TA validation threshold comprises a moving distance threshold value.

7. The method of claim 6, wherein the first time window is based on a first time (T1) corresponding to:
receiving, at the UE from the wireless network, a radio resource control (RRC) release command with a configured grant small data transmission (CG-SDT) configuration; and
at least one of:
receiving, at the UE from the wireless network, a latest TA value while the UE is in an RRC inactive state; and
updating, by the UE, a UE specific TA based on the first GNSS location measurement of the UE and a UE location change, and
wherein a first measurement time (T1′) within the first time window corresponds to the UE completing the first GNSS location measurement and estimating the first location of the UE.

8. The method of claim 7, wherein the second time window is based on a second time (T2) when the UE performs the TA validation for transmission using the CG-SDT, and
wherein a second measurement time (T2′) within the second time window corresponds to the UE completing the second GNSS location measurement and estimating the second location of the UE.

9. The method of claim 1, wherein durations of the first time window and the second time window are predetermined or configured to the UE by the wireless network.

10. The method of claim 1, further comprising:
in response to determining that the TA value is valid, sending an initial small data transmission (SDT) from the UE to a base station;
applying a UE specific TA estimated by the UE and a received TA command on a downlink reception timing from the wireless network to determine an STD transmission timing; and
using the STD transmission timing to send one or more subsequent SDT from the UE to the base station after the initial SDT.

11. A method for a base station to perform small data transmission (SDT) timing advance (TA) validation for a user equipment (UE) in a wireless network, the method comprising:
receiving, at the base station, UE information including a UE location, a UE velocity, and a UE trajectory;
determining, at the base station, TA information based on the UE information and a location of the base station, wherein the TA information includes a TA value and an SDT timer value within which the UE is allowed to transmit an initial SDT transmission according to the TA value;
transmitting, from the base station to the UE, a radio resource control (RRC) release command with a configured grant SDT (CG-SDT) configuration; and
transmitting, from the base station to the UE, the TA information.

12. The method of claim 11, further comprising transmitting, from the base station to the UE, updated TA information based on the UE information and the location of the base station.

13. The method of claim 12, wherein the base station periodically transmits the updated TA information after the RRC release with the CG-SDT configuration.

14. The method of claim 12, wherein the base station aperiodically transmits the updated TA information after the RRC release with the CG-SDT configuration based on a TA change or a round trip time (RTT) change that is greater than a threshold value.

15. The method of claim 11, wherein receiving the UE information comprises receiving the UE information at the base station from the UE.

16. The method of claim 11, wherein receiving the UE information comprises receiving the UE information at the base station from a traffic control system.

17. A method performed by a user equipment (UE) in a wireless network, the method comprising:
transmitting, from the UE to a base station, UE information including a UE location, a UE velocity, and a UE trajectory;
receiving, at the UE from the base station, a radio resource control (RRC) release command with a configured grant SDT (CG-SDT) configuration and timing advance (TA) information based on the UE information, wherein the TA information comprises a TA value and a small data transmission (SDT) timer value; and
transmitting, without TA validation by the UE, SDT from the UE to the base station according to the TA information until the TA value is updated or the SDT timer value is expired.

18. The method of claim 17, further comprising periodically receiving, at the UE from the base station, updated TA information after the RRC release with the CG-SDT configuration.

19. The method of claim 17, further comprising aperiodically receiving, at the UE from the base station, updated TA information after the RRC release with the CG-SDT configuration based on a TA change or a round trip time (RTT) change that is greater than a threshold value.

20-23. (canceled)
